(19) United States
(12) Patent Application Publication
(10) Pub. No.: US 2016/0380667 A1
(43) Pub. Date: Dec. 29, 2016

(54) HARMONIC-BASED CODING

(71) Applicant: QUALCOMM Incorporated, San Diego, CA (US)

(72) Inventor: Jaiprakash Chauhan, Hyderabad (IN)

(21) Appl. No.: 14/747,920

(22) Filed: Jun. 23, 2015

(51) Int. Cl. H04B 1/50; H04L 27/00

(52) U.S. Cl. CPC H04B 1/50; H04L 27/0014; H04L 2027/0051

(57) ABSTRACT

A communicated signal is made up of a fundamental frequency and zero or more harmonic frequencies of the fundamental frequency. These harmonic frequencies are selected to represent digital data (e.g., binary bits) according to a mapping of different digital patterns to different combinations of a fundamental frequency and zero or more harmonic frequencies of the fundamental frequency. For example, a transmit-side device may encode a given digital pattern as a signal made up of the corresponding fundamental frequency and zero or more harmonics indicated for that digital pattern in the mapping. The transmit-side device sends this signal to a receive-side device. The receive-side device may then identify the fundamental frequency and zero or more harmonics of the received signal and thereby determine, based on the mapping, the digital pattern sent by the transmit-side device.

### BACKGROUND

Field of the Disclosure

Aspects of the disclosure relate generally to communication, and more specifically, but not exclusively, to harmonic-based encoding and decoding.

Description of Related Art

There are different methods of sending digital data in bounded and unbounded media. In bounded media, unipolar, polar, and bipolar techniques may be employed. Here, digital data (e.g., binary bits) is sent using different voltage levels. Examples of these techniques include non-return-to-zero (NRZ) encoding, return-to-zero (RZ) encoding, Manchester encoding, and differential Manchester encoding.

In unbounded media, various digital modulation techniques may be used. Examples of these techniques include amplitude-shift keying (ASK), frequency-shift keying (FSK), phase-shift keying (PSK), quadrature amplitude modulation (QAM), and their variants.

One problem with the above techniques is that as the number of bits to be transmitted is increased, the number of transmitted symbols is also increased. Consequently, relatively complex circuits may be needed to generate and detect these symbols. Also, to overcome potential synchronization problems at the receiver end, violations may be added to the digital data being sent. The above factors tend to increase the complexity of the corresponding circuit designs.

### SUMMARY

The following presents a simplified summary of some aspects of the disclosure to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present various concepts of some aspects of the disclosure in a simplified form as a prelude to the more detailed description that is presented later.

A communicated signal is made up of a fundamental frequency and zero or more harmonic frequencies of the fundamental frequency. These harmonic frequencies are selected to represent digital data (binary bits) according to a mapping of different digital patterns to different combinations of a fundamental frequency and zero or more harmonic frequencies of the fundamental frequency. For example, a transmit-side device may encode a given digital pattern as a signal made up of the corresponding fundamental frequency and zero or more harmonics indicated for that digital pattern in the mapping. The transmit-side device sends this signal to a receive-side device. The receive-side device may then identify the fundamental frequency and zero or more harmonics of the received signal and thereby determine, based on the mapping, the digital pattern sent by the transmit-side device.

In one aspect, the disclosure provides an apparatus configured for communication including a memory circuit and a processing circuit coupled to the memory circuit. The processing circuit is configured to: receive a first signal; and generate a second signal based on the first signal and a mapping of different digital patterns to different combinations of a fundamental frequency and zero or more harmonic frequencies of the fundamental frequency.

Another aspect of the disclosure provides a method of communication including: receiving a first signal; and generating a second signal based on the first signal and a mapping of different digital patterns to different combinations of a fundamental frequency and zero or more harmonic frequencies of the fundamental frequency.

Another aspect of the disclosure provides an apparatus configured for communication. The apparatus including: means for receiving a first signal; and means for generating a second signal based on the first signal and a mapping of different digital patterns to different combinations of a fundamental frequency and zero or more harmonic frequencies of the fundamental frequency.

Another aspect of the disclosure provides a non-transitory computer readable medium storing computer executable code, including code to: receive a first signal; and generate a second signal based on the first signal and a mapping of different digital patterns to different combinations of a fundamental frequency and zero or more harmonic frequencies of the fundamental frequency.

Examples of additional aspects of the disclosure follow. In some aspects, the first signal includes a digital pattern; and the second signal includes an analog signal. In some aspects, the first signal includes a first digital pattern; the generation of the second signal includes identification, based on the mapping, of one of the combinations of the fundamental frequency and zero or more harmonic frequencies of the fundamental frequency that is mapped to the first digital pattern; and the second signal is generated based on the identified combination. In some aspects, the generation of the second signal includes generation of an analog signal that includes the identified combination of the fundamental frequency and zero or more harmonic frequencies of the fundamental frequency. In some aspects, the generation of the second signal includes generation of an indication of the identified combination of the fundamental frequency and zero or more harmonic frequencies of the fundamental frequency; and an analog signal is generated based on the indication, where the analog signal includes the identified combination of the fundamental frequency and zero or more harmonic frequencies of the fundamental frequency. In some aspects, the second signal has a periodicity corresponding to a periodicity of the fundamental frequency.

In some aspects, the first signal includes an analog signal; and the second signal includes a digital pattern. In some aspects, a first fundamental frequency of the first signal and zero or more harmonic frequencies of the first fundamental frequency in the first signal are identified. In some aspects, the generation of the second signal includes: identification, based on the mapping, of one of the digital patterns that is mapped to the first fundamental frequency and the zero or more harmonic frequencies of the first fundamental frequency; and generation of an indication of the identified digital pattern. In some aspects, the first signal has a periodicity corresponding to a periodicity of the fundamental frequency.

In some aspects, the mapping maps: a first digital pattern to a combination of the fundamental frequency and no harmonic frequencies of the fundamental frequency; and a second digital pattern to a combination of the fundamental frequency and a third harmonic frequency of the fundamental frequency. In some aspects, the mapping further maps: a third digital pattern to a combination of the fundamental frequency, a third harmonic frequency of the fundamental frequency, and a fifth harmonic frequency of the fundamental frequency. In some aspects, the mapping further maps: a fourth digital pattern to a combination of the fundamental frequency, a third harmonic frequency of the fundamental frequency, a fifth harmonic frequency of the fundamental frequency, and a seventh harmonic frequency of the fundamental frequency. In some aspects, the mapping further maps: a fifth digital pattern to a combination of the fundamental frequency, a third harmonic frequency of the fundamental frequency, a fifth harmonic frequency of the fundamental frequency, a seventh harmonic frequency of the fundamental frequency, and a ninth harmonic frequency of the fundamental frequency.

These and other aspects of the disclosure will become more fully understood upon a review of the detailed description, which follows. Other aspects, features, and implementations of the disclosure will become apparent to those of ordinary skill in the art, upon reviewing the following description of specific implementations of the disclosure in conjunction with the accompanying figures. While features of the disclosure may be discussed relative to certain implementations and figures below, all implementations of the disclosure can include one or more of the advantageous features discussed herein. In other words, while one or more implementations may be discussed as having certain advantageous features, one or more of such features may also be used in accordance with the various implementations of the disclosure discussed herein. In similar fashion, while certain implementations may be discussed below as device, system, or method implementations it should be understood that such implementations can be implemented in various devices, systems, and methods.

### BRIEF DESCRIPTION OF THE DRAWINGS

FIG. 1 illustrates an example of a communication system employing harmonic-based encoding and decoding in accordance with some aspects of the disclosure.

FIG. 2 illustrates an example time domain representation and frequency domain representation of a periodic waveform.

FIG. 3 illustrates an example time domain representation and frequency domain representation of a waveform corresponding to a first digital pattern.

FIG. 4 illustrates an example time domain representation and frequency domain representation of a waveform corresponding to a second digital pattern.

FIG. 5 illustrates an example time domain representation and frequency domain representation of a waveform corresponding to a third digital pattern.

FIG. 6 illustrates an example time domain representation and frequency domain representation of a waveform corresponding to a fourth digital pattern.

FIG. 7 illustrates an example time domain representation and frequency domain representation of a waveform corresponding to a fifth digital pattern.

FIG. 8 illustrates an example of an apparatus for harmonic-based coding in accordance with some aspects of the disclosure.

FIG. 9 illustrates an example of an apparatus for harmonic-based encoding in accordance with some aspects of the disclosure.

FIG. 10 illustrates an example of an apparatus for harmonic-based decoding in accordance with some aspects of the disclosure.

FIG. 11 is a block diagram of an example hardware implementation for an apparatus (e.g., an electronic device) for harmonic coding in accordance with some aspects of the disclosure.

FIG. 12 illustrates an example of a harmonic coding process in accordance with some aspects of the disclosure.

FIG. 13 illustrates an example of a harmonic encoding process in accordance with some aspects of the disclosure.

FIG. 14 illustrates an example of a harmonic decoding process in accordance with some aspects of the disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

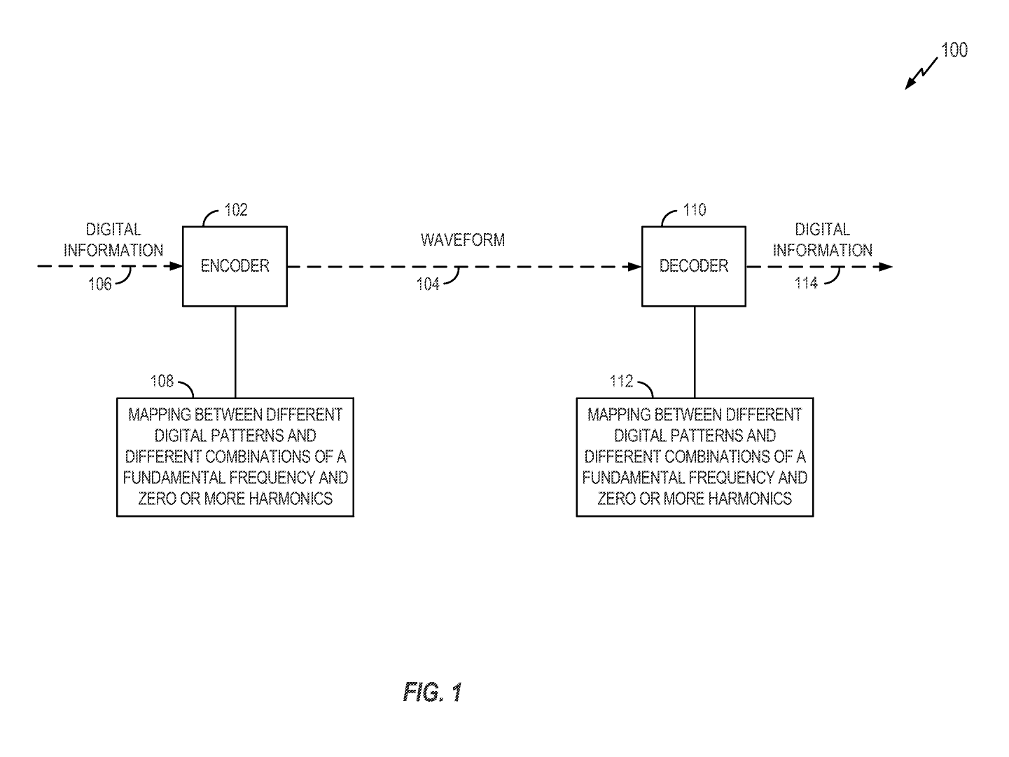

FIG. 1 illustrates a communication system 100 where signals are coded (encoded or decoded) based on a mapping between different digital patterns and different combinations of a fundamental frequency and zero or more harmonics of the fundamental frequency. An encoder 102 generates a waveform 104 based on received digital information 106 and a mapping 108.

The mapping 108 maps different digital patterns to different combinations of a fundamental frequency (e.g., F0) and zero or more harmonic frequencies of the fundamental frequency. As one non-limiting example, the different digital patterns may include: 0000, 1000, 1100, and so on. As one non-limiting example, the different combinations may include: F0 alone, F0 and the third harmonic of F0, F0 and the third and fifth harmonics of F0, and so on.

The waveform 104 generated for a particular digital pattern includes the frequency components associated with that particular digital pattern. For example, the encoder 102 may generate a waveform that includes F0 alone if the received digital pattern is 0000. As another example, the encoder 102 may generate a waveform that includes F0 and the third harmonic of F0 if the received digital pattern is 1000.

A decoder 110 decodes the received waveform 104 based on a mapping 112 that corresponds to the mapping 108. To this end, the decoder 110 identifies the frequency components of the waveform 104. That is, the decoder 110 determines the fundamental frequency (e.g., F0) of the waveform 104 and also determines whether the waveform 104 also includes any of the harmonic frequencies of the fundamental frequency.

The decoder 110 then compares this frequency information to entries in the mapping 112 to determine which digital pattern is mapped to that frequency information. Continuing with the above example, if a waveform includes F0 alone, the corresponding digital pattern is 0000. If a waveform includes F0 and the third harmonic of F0, the corresponding digital pattern is 1000. The decoder 110 can thus output digital information 114 representative of the detected digital pattern.

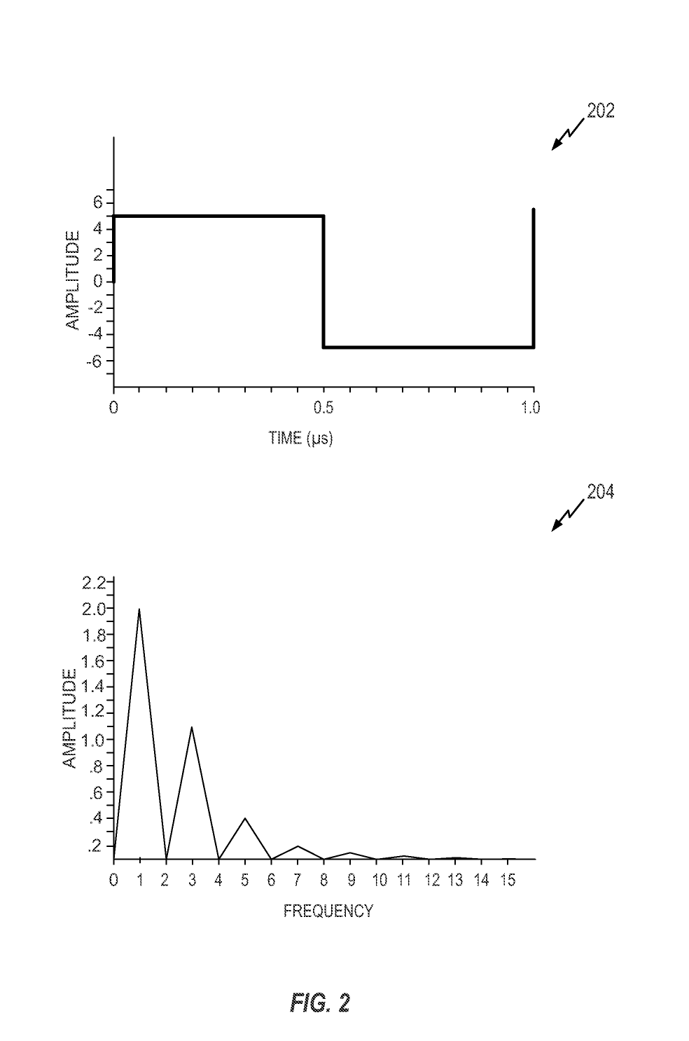

The fundamental frequency and harmonic frequency components of various signals and the mapping of these components to different digital patterns will be described in more detail with reference to FIGS. 2-7. Fourier Transform shows that signals are made of sine and cosine components having fundamental and harmonic frequencies added suitably.

The disclosure relates in some aspects to using these harmonic frequencies to encode digital data (e.g., binary bits) so that the digital data can be efficiently communicated from a transmitting device to a receiving device. At the transmitting device, a signal is generated according to a constituent fundamental frequency and zero or more harmonics of the fundamental frequency. The decision of whether to include any of the harmonics is based on the bit pattern to be communicated. The fundamental signal and any chosen harmonics may then be combined, if applicable, to produce the final electrical signal to be transmitted. At the receiving device, the signal is decomposed using Fourier Transform and the bit information being communicated is determined based on the harmonics in the signal, if any.

This method can be used for both bounded and unbounded media. In unbounded media, the signal is upconverted for transmission at the transmitting device and downconverted at the receiving device.

Referring to FIG. 2, consider a NRZ periodic wave 202 having an amplitude of ±5 V and a time period of 1 μs as shown. The Fourier series is given by:

$$F ( t ) = 20 / π [ sin ( 2 π ft ) + ( \frac{1}{3} ) * sin ( 6 π ft ) + ( \frac{1}{5} ) * sin ( 10 π ft ) + ( \frac{1}{7} ) * sin ( 14 π ft ) + ( \frac{1}{9} ) * sin ( 18 π ft ) + … ]$$

Only the fundamental and the first four terms (3^{rd}, 5^{th}, 7^{th}, and 9^{th} harmonics) are taken for explanation. The magnitude plot in the frequency domain 204 is also shown in FIG. 2. Here, the fundamental frequency scaled down so the harmonic terms can be seen clearly.

In an example implementation, the four harmonics can be used to encode 4-bit digital data as: 3^{rd} harmonic=LSB (least significant bit) of the 4-bit pattern, 5^{th} harmonic=2^{nd} LSB of the 4-bit pattern, 7^{th} harmonic=2^{nd} MSB (most significant bit) of the 4-bit pattern, and 9^{th} harmonic=MSB of the 4-bit pattern.

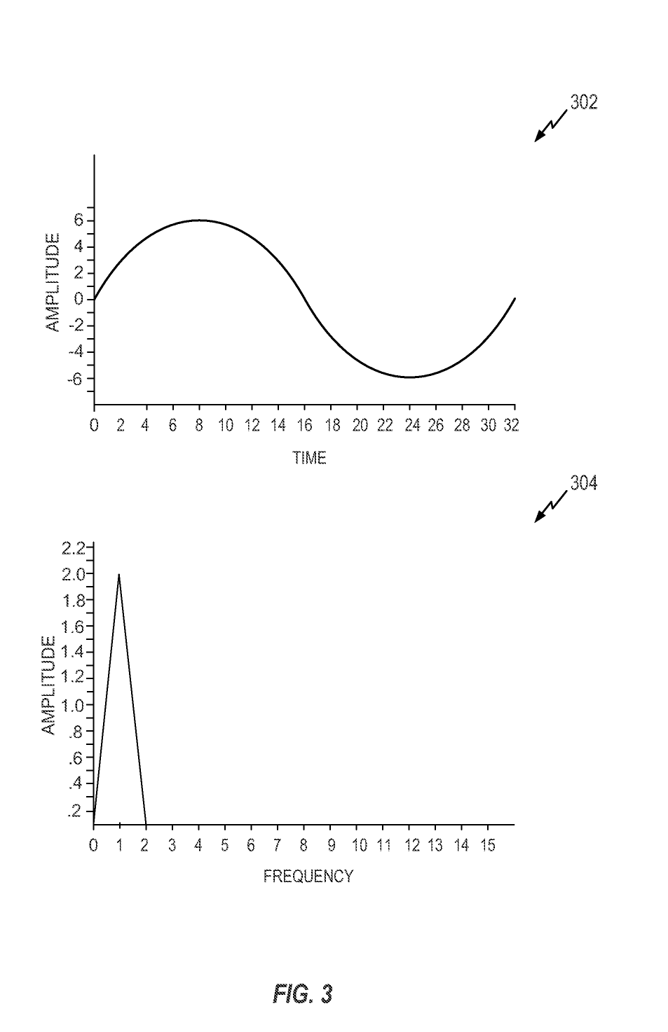

FIG. 3 illustrates a waveform 302 that only includes the fundamental frequency. Thus, the magnitude plot in the frequency domain 304 only shows a magnitude for the fundamental frequency. In some implementations, this waveform may be mapped to a 0000 digital pattern.

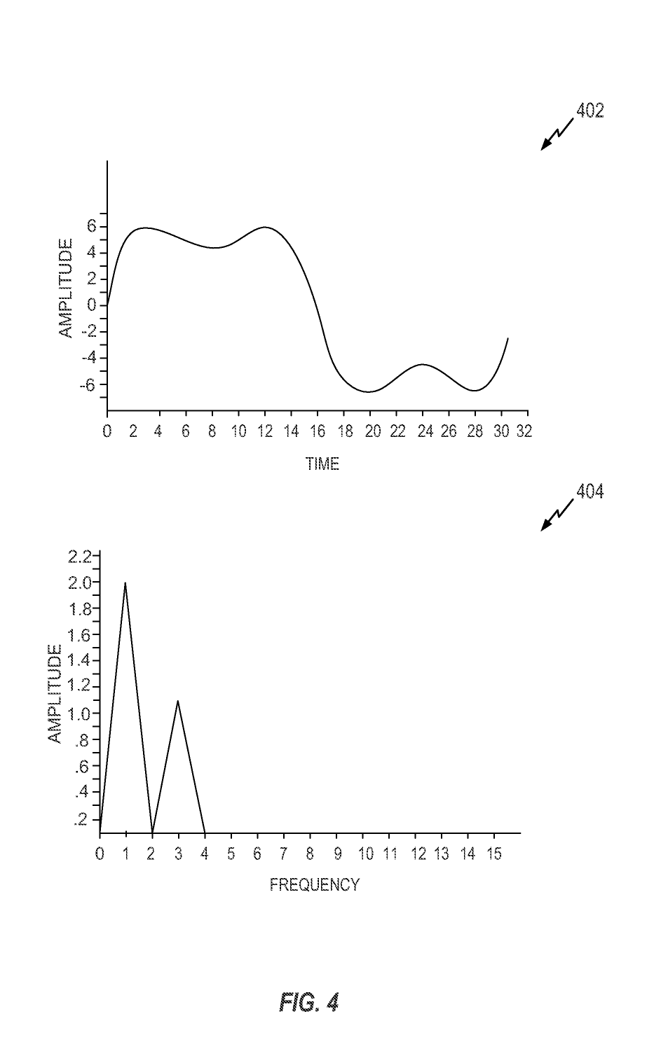

FIG. 4 illustrates a waveform 402 that includes the fundamental frequency and the third harmonic. Thus, the magnitude plot in the frequency domain 404 shows a magnitude for each of the fundamental frequency and the third harmonic. In some implementations, this waveform may be mapped to a 1000 digital pattern.

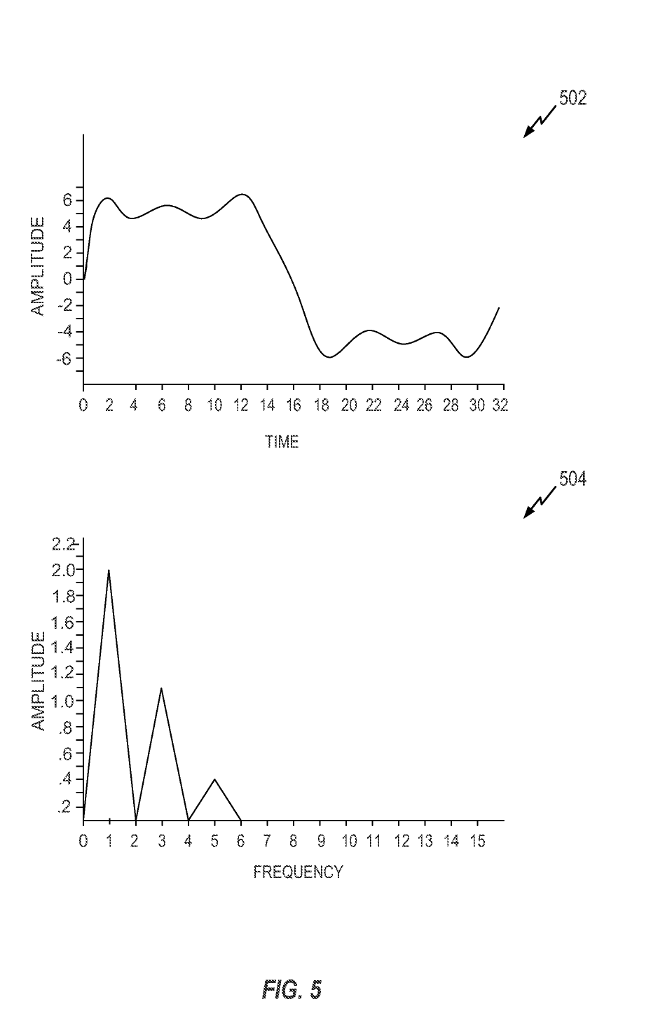

FIG. 5 illustrates a waveform 502 that includes the fundamental frequency, the third harmonic, and the fifth harmonic. Thus, the magnitude plot in the frequency domain 504 shows a magnitude for each of the fundamental frequency, the third harmonic, and the fifth harmonic. In some implementations, this waveform may be mapped to a 1100 digital pattern.

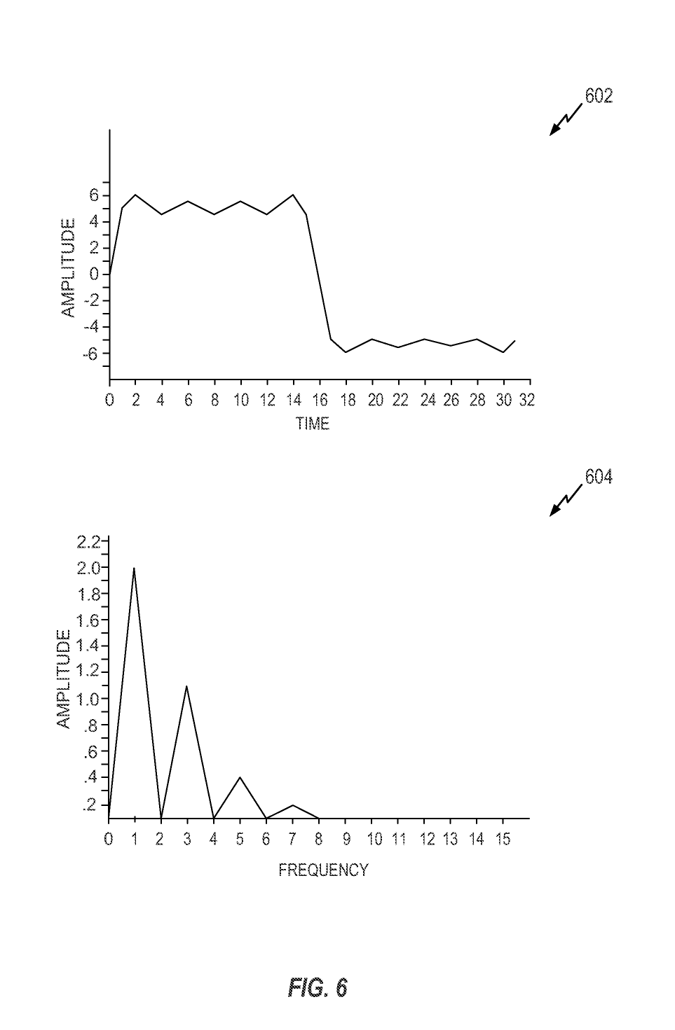

FIG. 6 illustrates a waveform 602 that includes the fundamental frequency, the third harmonic, the fifth harmonic, and the seventh harmonic. Thus, the magnitude plot in the frequency domain 604 shows a magnitude for each of the fundamental frequency, the third harmonic, the fifth harmonic, and the seventh harmonic. In some implementations, this waveform may be mapped to a 1110 digital pattern.

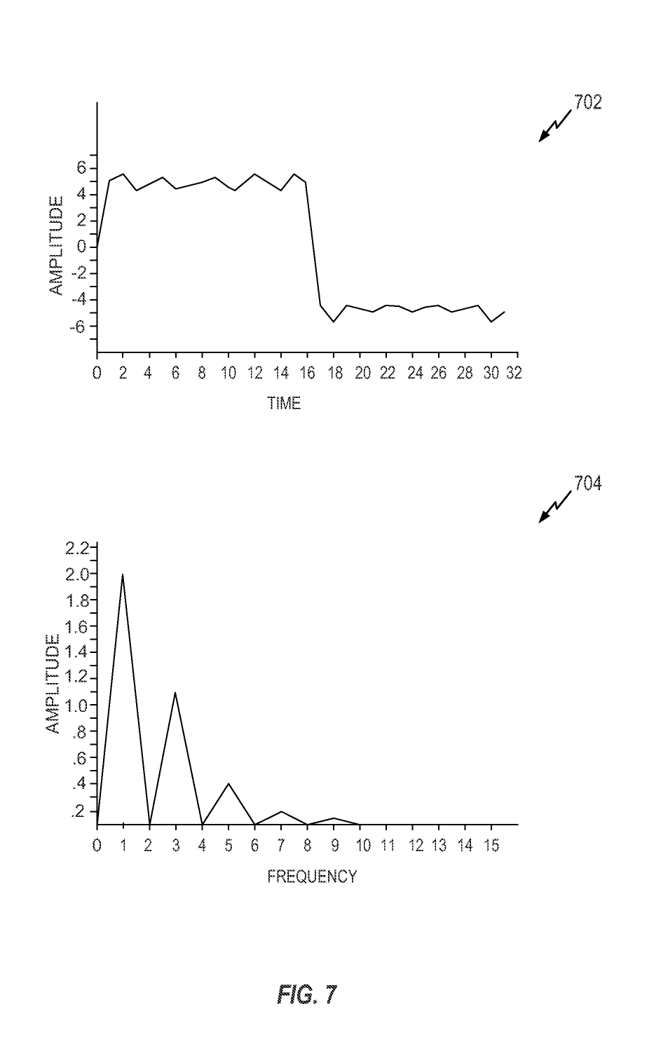

FIG. 7 illustrates a waveform 702 that includes the fundamental frequency, the third harmonic, the fifth harmonic, the seventh harmonic, and the ninth harmonic. Thus, the magnitude plot in the frequency domain 704 shows a magnitude for each of the fundamental frequency, the third harmonic, the fifth harmonic, the seventh harmonic, and the ninth harmonic. In some implementations, this waveform may be mapped to a 1111 digital pattern.

Other mappings between harmonics and digital patterns may be used in other implementations. For example, different implementations may use a different number of harmonics (e.g., two, three, five, etc.). As another example, the harmonics may be mapped to different digital patterns in different implementations (e.g., to 00, 01, 10, 11, etc.).

The particular configuration used for a given implementation may depend on one or more design constraints of the implementation. For example, the fundamental frequency and harmonics for a given scenario may be selected based on the channel bandwidth that is available for transmitting the encoded waveform (e.g., any of the waveforms 302, 402, 502, 602, or 702). Here, the fundamental frequency and harmonics may be selected to properly utilize the channel and/or send the maximum number of data bits possible.

The use of the disclosed techniques may provide one or more advantages. In some aspects, the communicated data rate may exceed the baud rate of the transmitted signal, depending on how many bits are sent. In addition, since signal transitions may be provided for each data pattern (e.g., as shown in the waveforms 302, 402, 502, 602, and 702), signal synchronization may be readily achieved at a receiving device.

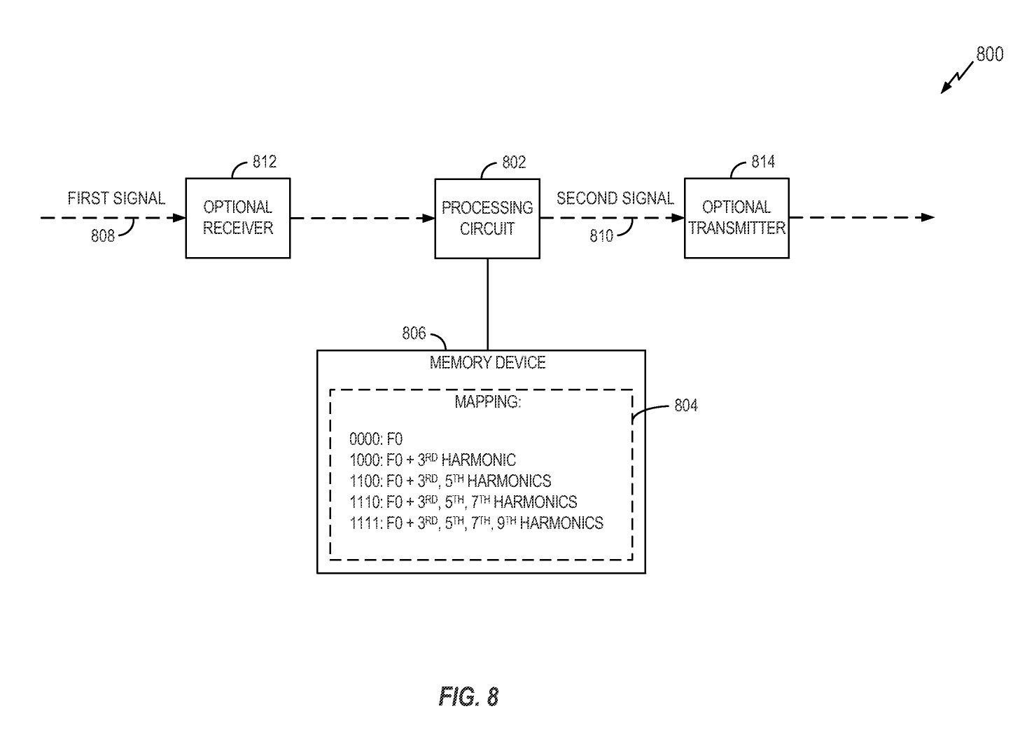

FIG. 8 illustrates an example of an apparatus 800 that codes (encodes or decodes) signals based on a mapping as taught herein. A processing circuit 802 uses a mapping 804 stored in a memory device 806 to process a first signal 808 and thereby generate a second signal 810.

As indicated, the mapping 804 maps different digital patterns to different combinations of a fundamental frequency (e.g., F0) and zero or more harmonic frequencies of the fundamental frequency. In this example, the digital pattern 0000 is mapped to F0 alone, the digital pattern 1000 is mapped to F0 and the third harmonic of F0, the digital pattern 1100 is mapped to F0 and the third and fifth harmonics of F0, and so on.

The waveform generated for a particular digital pattern includes the frequency components associated with that particular digital pattern. For example, a waveform that includes F0 alone may correspond to a digital pattern of 0000. As another example, a waveform that includes F0 and the third harmonic of F0 may correspond to a digital pattern of 1000.

As indicated, the apparatus 800 may optionally include a receiver 812 for receiving the first signal 808. For example, the receiver 812 could be a communication device, a bus interface device, a memory interface, a buffer, or some other suitable circuit.

Also as indicated, the apparatus 800 may optionally include a transmitter 814 for transmitting the second signal 810. For example, the transmitter 814 could be a communication device, a bus interface device, a memory interface, a driver, or some other suitable circuit.

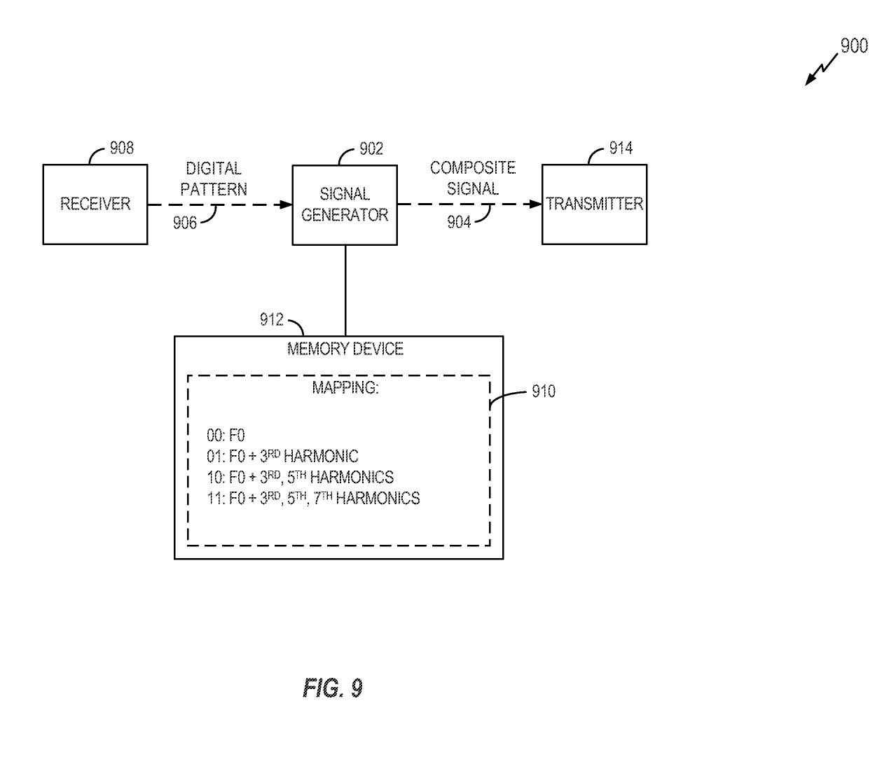

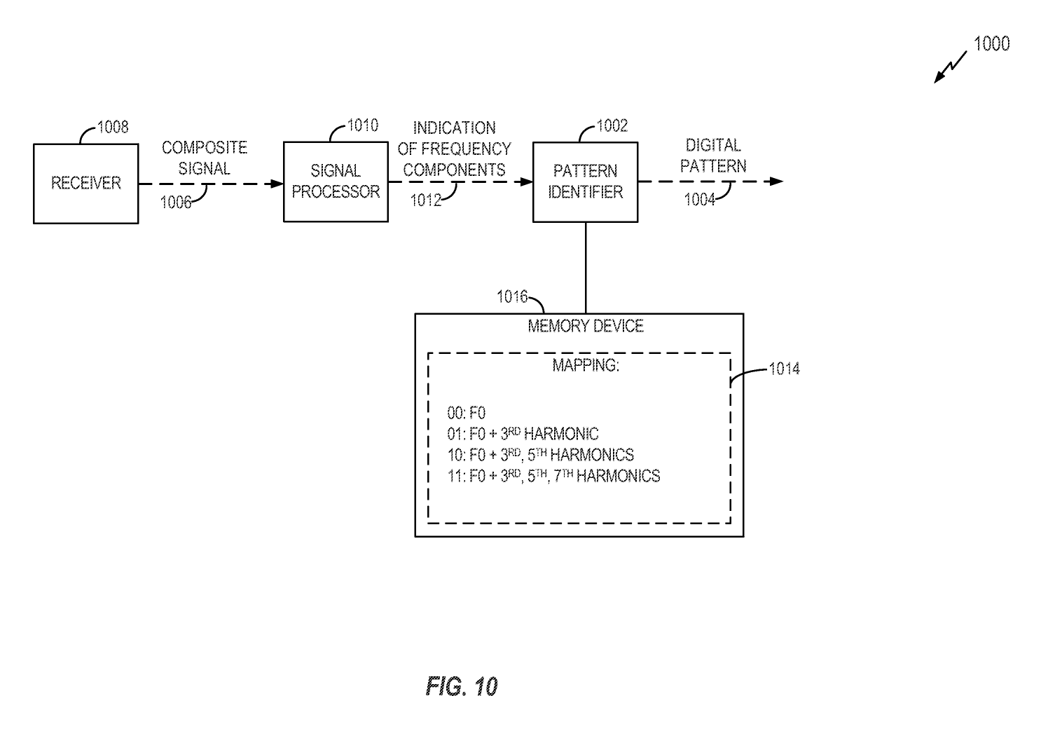

In various implementations, the apparatus 800 may encode a received digital pattern to generate an analog waveform and/or decode a received analog waveform to identify the digital pattern represented by that waveform. Examples of these two scenarios will be discussed in more detail in conjunction with FIGS. 9 and 10.

FIG. 9 illustrates an apparatus 900 (e.g., an example of the apparatus 800) that encodes signals based on a mapping as taught herein. A signal generator 902 generates a composite signal 904 based on a digital pattern received by a receiver 908 and a mapping 910 stored in a memory device 912.

The mapping 910 illustrates another example of a mapping between different digital patterns and different combinations of a fundamental frequency (e.g., F0) and zero or more harmonic frequencies of the fundamental frequency. In this example, the digital pattern 00 is mapped to F0 alone, the digital pattern 01 is mapped to F0 and the third harmonic of F0, the digital pattern 10 is mapped to F0 and the third and fifth harmonics of F0, and the digital pattern 11 is mapped to F0 and the third, fifth, and seventh harmonics of F0.

The composite signal 904 generated for a particular digital pattern either indicates or includes the frequency components associated with that particular digital pattern. For example, the signal generator 902 may generate an analog waveform that includes F0 alone if the received digital pattern is 00, the signal generator 902 may generate an analog waveform that includes F0 and the third harmonic of F0 if the received digital pattern is 01, and so on. As another example, the signal generator 902 may generate a digital signal that only includes an F0 component if the received digital pattern is 00, the signal generator 902 may generate a digital signal that includes components for F0 and the third harmonic of F0 if the received digital pattern is 01, and so on. This latter example may be employed, for example, in implementations where the signal generator 902 is a digital device that sends digital waveform information to a transmitter that generates an analog waveform based on the digital waveform information.

As indicated, the apparatus 900 includes a transmitter 914 for transmitting the composite signal 904. As discussed herein, the transmitter 914 could be a communication device, a bus interface device, a memory interface, a driver, or some other suitable circuit.

FIG. 10 illustrates an apparatus 1000 (e.g., an example of the apparatus 800) that decodes signals based on a mapping as taught herein. A pattern identifier 1002 generates a digital pattern 1004 based on a composite signal 1006 received by a receiver 1008. A signal processor 1010 performs a frequency analysis of the composite signal 1006 and generates an indication 1012 of the frequency components of the composite signal. For example, the composite signal 1006 may be an analog waveform (or digital representation thereof) and the indication 1012 may indicate the fundamental frequency of the waveform as well as any harmonics present in the waveform. The pattern identifier 1002 can therefore compare this frequency information to entries in a mapping 1014 (stored in a memory device 1016) to determine which digital pattern is mapped to that frequency information. Continuing with the example of FIG. 9, if a waveform includes F0 alone, the corresponding digital pattern is 00. If a waveform includes F0 and the third harmonic of F0, the corresponding digital pattern is 01, and so on.

### Example Apparatus

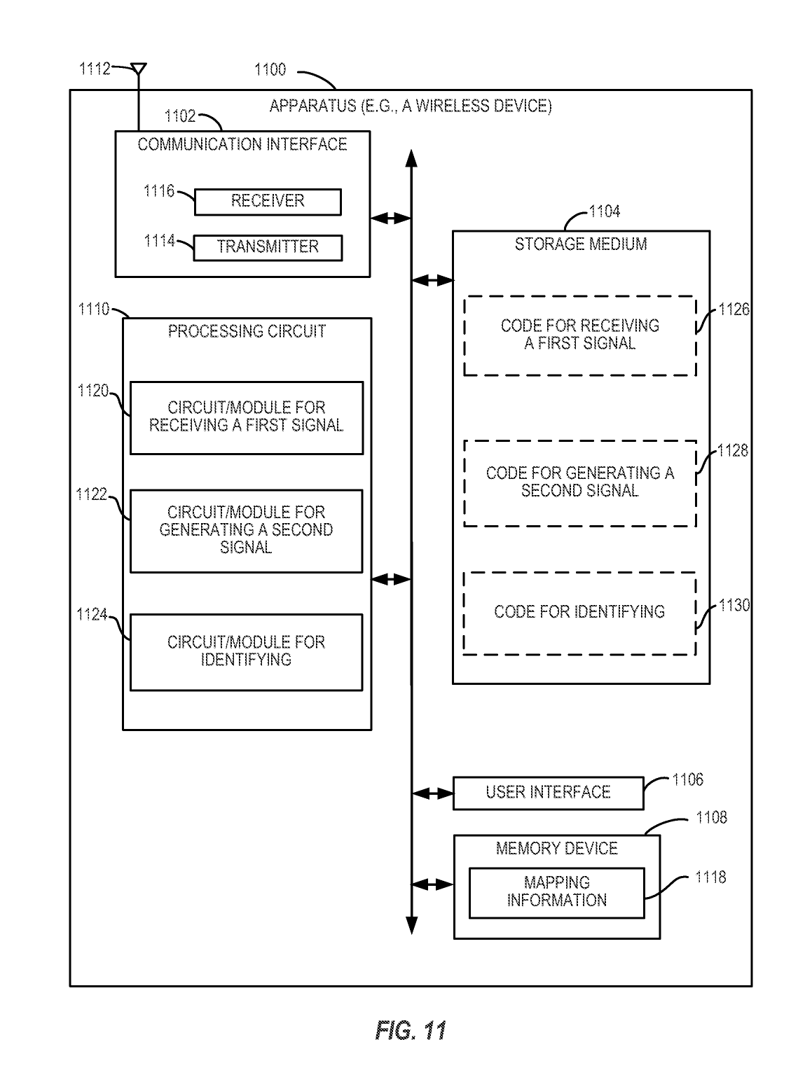

FIG. 11 is an illustration of an apparatus 1100 that may support harmonic-based coding according to one or more aspects of the disclosure. The apparatus 1100 includes a communication interface (e.g., at least one transceiver) 1102, a storage medium 1104, a user interface 1106, a memory device 1108, and a processing circuit 1110.

These components can be coupled to and/or placed in electrical communication with one another via a signaling bus or other suitable component, represented generally by the connection lines in FIG. 11. The signaling bus may include any number of interconnecting buses and bridges depending on the specific application of the processing circuit 1110 and the overall design constraints. The signaling bus links together various circuits such that each of the communication interface 1102, the storage medium 1104, the user interface 1106, and the memory device 1108 are coupled to and/or in electrical communication with the processing circuit 1110. The signaling bus may also link various other circuits (not shown) such as timing sources, peripherals, voltage regulators, and power management circuits, which are well known in the art, and therefore, will not be described any further.

The communication interface 1102 may be adapted to facilitate wireless communication of the apparatus 1100. For example, the communication interface 1102 may include circuitry and/or programming adapted to facilitate the communication of information bi-directionally with respect to one or more communication devices in a network. In some implementations, the communication interface 1102 may be configured for wire-based communication. In some implementations, the communication interface 1102 may be coupled to one or more antennas 1112 for wireless communication within a wireless communication system. The communication interface 1102 can be configured with one or more standalone receivers and/or transmitters, as well as one or more transceivers. In the illustrated example, the communication interface 1102 includes a transmitter 1114 and a receiver 1116.

The memory device 1108 may represent one or more memory devices. As indicated, the memory device 1108 may maintain mapping information 1118 along with other information used by the apparatus 1100. In some implementations, the memory device 1108 and the storage medium 1104 are implemented as a common memory component. The memory device 1108 may also be used for storing data that is manipulated by the processing circuit 1110 or some other component of the apparatus 1100.

The storage medium 1104 may represent one or more computer-readable, machine-readable, and/or processor-readable devices for storing programming, such as processor executable code or instructions (e.g., software, firmware), electronic data, databases, or other digital information. The storage medium 1104 may also be used for storing data that is manipulated by the processing circuit 1110 when executing programming. The storage medium 1104 may be any available media that can be accessed by a general purpose or special purpose processor, including portable or fixed storage devices, optical storage devices, and various other mediums capable of storing, containing or carrying programming.

By way of example and not limitation, the storage medium 1104 may include a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The storage medium 1104 may be embodied in an article of manufacture (e.g., a computer program product). By way of example, a computer program product may include a computer-readable medium in packaging materials. In view of the above, in some implementations, the storage medium 1104 may be a non-transitory (e.g., tangible) storage medium.

The storage medium 1104 may be coupled to the processing circuit 1110 such that the processing circuit 1110 can read information from, and write information to, the storage medium 1104. That is, the storage medium 1104 can be coupled to the processing circuit 1110 so that the storage medium 1104 is at least accessible by the processing circuit 1110, including examples where at least one storage medium is integral to the processing circuit 1110 and/or examples where at least one storage medium is separate from the processing circuit 1110 (e.g., resident in the apparatus 1100, external to the apparatus 1100, distributed across multiple entities, etc.).

Programming stored by the storage medium 1104, when executed by the processing circuit 1110, causes the processing circuit 1110 to perform one or more of the various functions and/or process operations described herein. For example, the storage medium 1104 may include operations configured for regulating operations at one or more hardware blocks of the processing circuit 1110, as well as to utilize the communication interface 1102 for wireless communication utilizing their respective communication protocols.

The processing circuit 1110 is generally adapted for processing, including the execution of such programming stored on the storage medium 1104. As used herein, the term “programming” shall be construed broadly to include without limitation instructions, instruction sets, data, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

The processing circuit 1110 is arranged to obtain, process and/or send data, control data access and storage, issue commands, and control other desired operations. The processing circuit 1110 may include circuitry configured to implement desired programming provided by appropriate media in at least one example. For example, the processing circuit 1110 may be implemented as one or more processors, one or more controllers, and/or other structure configured to execute executable programming. Examples of the processing circuit 1110 may include a general purpose processor, a digital signal processor (DSP), an application specific integrated circuit (ASIC), a field programmable gate array (FPGA) or other programmable logic component, discrete gate or transistor logic, discrete hardware components, or any combination thereof designed to perform the functions described herein. A general purpose processor may include a microprocessor, as well as any conventional processor, controller, microcontroller, or state machine. The processing circuit 1110 may also be implemented as a combination of computing components, such as a combination of a DSP and a microprocessor, a number of microprocessors, one or more microprocessors in conjunction with a DSP core, an ASIC and a microprocessor, or any other number of varying configurations. These examples of the processing circuit 1110 are for illustration and other suitable configurations within the scope of the disclosure are also contemplated.

According to one or more aspects of the disclosure, the processing circuit 1110 may be adapted to perform any or all of the features, processes, functions, operations and/or routines for any or all of the apparatuses described herein. As used herein, the term “adapted” in relation to the processing circuit 1110 may refer to the processing circuit 1110 being one or more of configured, employed, implemented, and/or programmed to perform a particular process, function, operation and/or routine according to various features described herein.

According to at least one example of the apparatus 1100, the processing circuit 1110 may include one or more of a circuit/module for receiving a first signal 1120, a circuit/module for generating a second signal 1122, and a circuit/module for identifying 1124.

The circuit/module for receiving a first signal 1120 may include circuitry and/or programming (e.g., code for receiving a first signal 1126 stored on the storage medium 1104) adapted to perform several functions relating to, for example, receiving a digital pattern or receiving a digital representation of an analog signal. Thus, in some implementations, the circuit/module for receiving a first signal 1120 is a receiver configured to receive digital signals. In addition, in some implementations, the circuit/module for receiving a first signal 1120 is a receiver configured to receive a digital representation of an analog signal (e.g., from a radio frequency (RF) receiver that receives RF signals).

In some implementations, the circuit/module for receiving a first signal 1120 obtains information directly from a device that transmitted the information or from a component of the apparatus 1100 (e.g., the receiver 1116, the memory device 1108, or some other component). In some implementations, the circuit/module for receiving a first signal 1120 identifies a memory location of a value in the memory device 1108 and invokes a read of that location. In some implementations, the circuit/module for receiving a first signal 1120 processes (e.g., decodes) the obtained information. The circuit/module for receiving a first signal 1120 then outputs the information to a component of the apparatus 1100 (e.g., the memory device 1108, the circuit/module for generating a second signal 1122, or some other component). In some implementations, the receiver 1116 includes the circuit/module for receiving a first signal 1120 and/or the code for receiving a first signal 1126.

The circuit/module for generating a second signal 1122 may include circuitry and/or programming (e.g., code for generating a second signal 1128 stored on the storage medium 1104) adapted to perform several functions relating to, for example, generating a signal indicative of a fundamental frequency and zero or more harmonics mapped to the first signal (e.g., mapped to a digital pattern) or generating a digital pattern mapped to the first signal (e.g., mapped to a fundamental frequency and zero or more harmonics).

For example, in the event the first signal is a digital pattern, the circuit/module for generating a second signal 1122 may compare the digital pattern with the digital patterns entries in a mapping as discussed herein. In this way, the circuit/module for generating a second signal 1122 can identify the fundamental frequency and zero or more harmonics that are mapped to that digital pattern. The circuit/module for generating a second signal 1122 may then generate a signal (e.g., a digital representation of the signal) that includes the fundamental frequency and any harmonics corresponding to the digital pattern. In some implementations, the circuit/module for generating a second signal 1122 sends this generated signal to another component of the apparatus (e.g., the transmitter 1114) that generates a corresponding analog signal (e.g., a signal corresponding to any of waveforms 302, 402, 502, 602, or 702, or an RF signal).

As another example, in the event the first signal is an analog signal or digital representation thereof, the circuit/module for generating a second signal 1122 may obtain an indication of the fundamental frequency and any harmonics of the signal (e.g., from the circuit/module for identifying 1124 or some other component of the apparatus 1100). The circuit/module for generating a second signal 1122 may compare the fundamental frequency and any harmonics with the frequency/harmonic entries in a mapping as discussed herein. In this way, the circuit/module for generating a second signal 1122 can identify the digital pattern that is mapped to that fundamental frequency and zero or more harmonics. Thus, the circuit/module for generating a second signal 1122 generates a second signal that is a digital pattern that corresponds to the fundamental frequency and any harmonics of the first signal (e.g., an analog signal).

The circuit/module for identifying 1124 may include circuitry and/or programming (e.g., code for identifying 1130 stored on the storage medium 1104) adapted to perform several functions relating to, for example, identifying a fundamental frequency and zero or more harmonics mapped to a digital pattern. Initially, the circuit/module for identifying 1124 receives a signal (e.g., from the receiver 1116, the memory device 1108, or some other component). The circuit/module for identifying 1124 then performs frequency analysis on the signal to identify a fundamental frequency of the signal and any harmonics of that fundamental frequency. The circuit/module for identifying 1124 then outputs an indication of the identified fundamental frequency and any harmonics to a component of the apparatus 1100 (e.g., the memory device 1108, the circuit/module for generating a second signal 1122, or some other component).

As mentioned above, programming stored by the storage medium 1104, when executed by the processing circuit 1110, causes the processing circuit 1110 to perform one or more of the various functions and/or process operations described herein. For example, the storage medium 1104 may include one or more of the code for receiving a first signal 1126, the code for generating a second signal 1128, or the code for identifying 1130.

### Example Processes

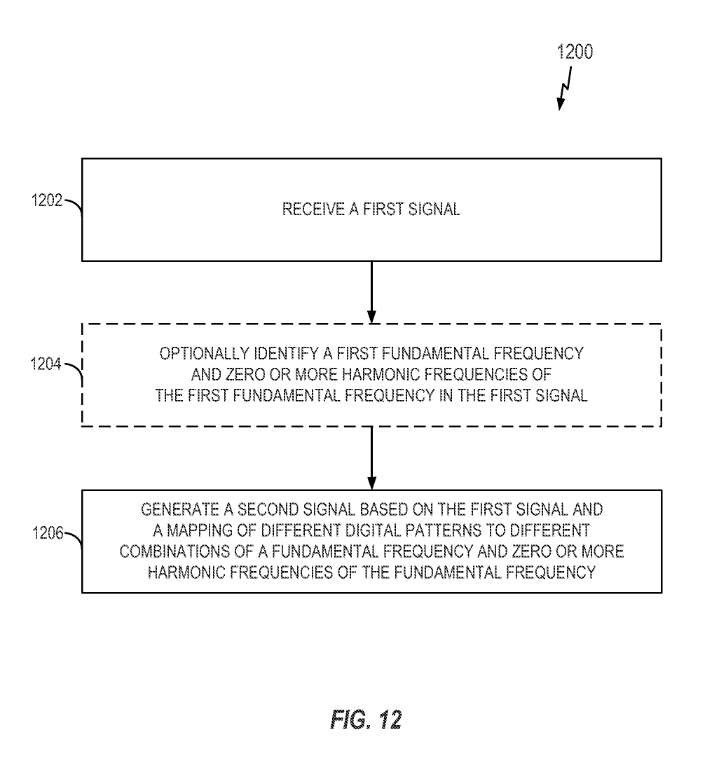

FIG. 12 illustrates a process 1200 for communication in accordance with some aspects of the disclosure. The process 1200 may take place within a processing circuit (e.g., the processing circuit 1110 of FIG. 11), which may be located in an electronic device or some other suitable apparatus. In some implementations, the process 1200 represents operations performed by the apparatus 800 of FIG. 8. Of course, in various aspects within the scope of the disclosure, the process 1200 may be implemented by any suitable apparatus capable of supporting communication operations as taught herein.

At block 1202, an apparatus receives a first signal. For example, a processing circuit may receive a signal comprising digital data from a memory device, a processing circuit may receive a digital representation of an analog signal, or a receiver of the apparatus may receive an analog signal.

At optional block 1204, in the event the first signal is an analog signal or a digital representation of an analog signal, the apparatus may identify a first fundamental frequency of the first signal and zero or more harmonic frequencies of the first fundamental frequency in the first signal.

At block 1206, the apparatus generates a second signal based on the first signal and a mapping of different digital patterns to different combinations of a fundamental frequency and zero or more harmonic frequencies of the fundamental frequency. For example, in the event the first signal is a digital pattern, the second signal may be an analog signal that includes the fundamental frequency and any harmonics corresponding to the digital pattern. As another example, in the event the first signal is an analog signal or a digital representation thereof, the second signal may be a digital pattern that corresponds to the fundamental frequency and any harmonics of the analog signal.

In some aspects, the mapping maps: a first digital pattern to a combination of the fundamental frequency and no harmonic frequencies of the fundamental frequency; and a second digital pattern to a combination of the fundamental frequency and a third harmonic frequency of the fundamental frequency. In some aspects, the mapping further maps: a third digital pattern to a combination of the fundamental frequency, a third harmonic frequency of the fundamental frequency, and a fifth harmonic frequency of the fundamental frequency. In some aspects, the mapping further maps: a fourth digital pattern to a combination of the fundamental frequency, a third harmonic frequency of the fundamental frequency, a fifth harmonic frequency of the fundamental frequency, and a seventh harmonic frequency of the fundamental frequency. In some aspects, the mapping further maps: a fifth digital pattern to a combination of the fundamental frequency, a third harmonic frequency of the fundamental frequency, a fifth harmonic frequency of the fundamental frequency, a seventh harmonic frequency of the fundamental frequency, and a ninth harmonic frequency of the fundamental frequency.

In view of the above, in some aspects, the first signal includes a digital pattern; and the second signal includes an analog signal. In some aspects, the first signal includes a first digital pattern; the generation of the second signal includes identification, based on the mapping, of one of the combinations of the fundamental frequency and zero or more harmonic frequencies of the fundamental frequency that is mapped to the first digital pattern; and the second signal is generated based on the identified combination. In some aspects, the generation of the second signal includes generation of an analog signal that includes the identified combination of the fundamental frequency and zero or more harmonic frequencies of the fundamental frequency. In some aspects, the generation of the second signal includes generation of an indication of the identified combination of the fundamental frequency and zero or more harmonic frequencies of the fundamental frequency; and an analog signal is generated based on the indication, where the analog signal includes the identified combination of the fundamental frequency and zero or more harmonic frequencies of the fundamental frequency. In some aspects, the second signal has a periodicity corresponding to a periodicity of the fundamental frequency.

Also in view of the above, in some aspects, the first signal includes an analog signal; and the second signal includes a digital pattern. In some aspects, a first fundamental frequency of the first signal and zero or more harmonic frequencies of the first fundamental frequency in the first signal are identified. In some aspects, the generation of the second signal includes: identification, based on the mapping, of one of the digital patterns that is mapped to the first fundamental frequency and the zero or more harmonic frequencies of the first fundamental frequency; and generation of an indication of the identified digital pattern. In some aspects, the first signal has a periodicity corresponding to a periodicity of the fundamental frequency.

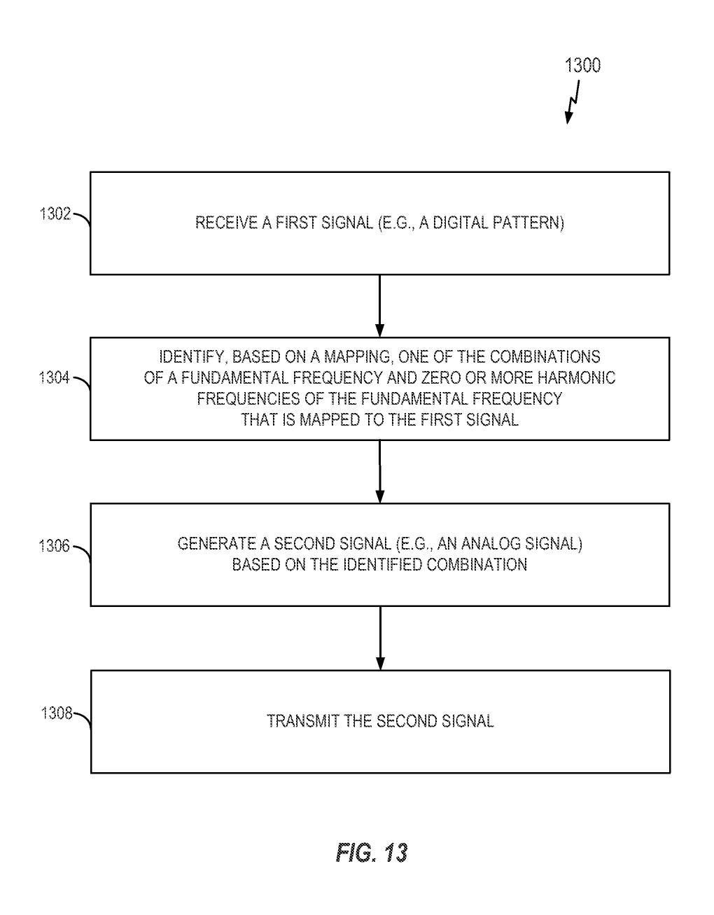

FIG. 13 illustrates a process 1300 for communication in accordance with some aspects of the disclosure. In some implementations, the process 1300 may be a form of the process 1200 of FIG. 12. The process 1300 may take place within a processing circuit (e.g., the processing circuit 1110 of FIG. 11), which may be located in an electronic device or some other suitable apparatus. In some implementations, the process 1300 represents operations performed by the apparatus 800 of FIG. 8, or the apparatus 900 of FIG. 9. Of course, in various aspects within the scope of the disclosure, the process 1300 may be implemented by any suitable apparatus capable of supporting communication operations as taught herein.

At block 1302, an apparatus receives a first signal. For example, a processing circuit may receive a signal comprising digital data (e.g., a first digital pattern) from a memory device or some other device.

At block 1304, the apparatus identifies, based on a mapping, one of the combinations of the fundamental frequency and zero or more harmonic frequencies of the fundamental frequency that is mapped to the first signal (e.g., the first digital pattern).

At block 1306, the apparatus generates a second signal based on the identified combination. For example, the second signal may be an analog signal that includes the fundamental frequency and any harmonics corresponding to the first digital pattern.

At block 1308, the apparatus transmits the second signal. For example an encoding device may send the second signal to a decoding device over a communication medium.

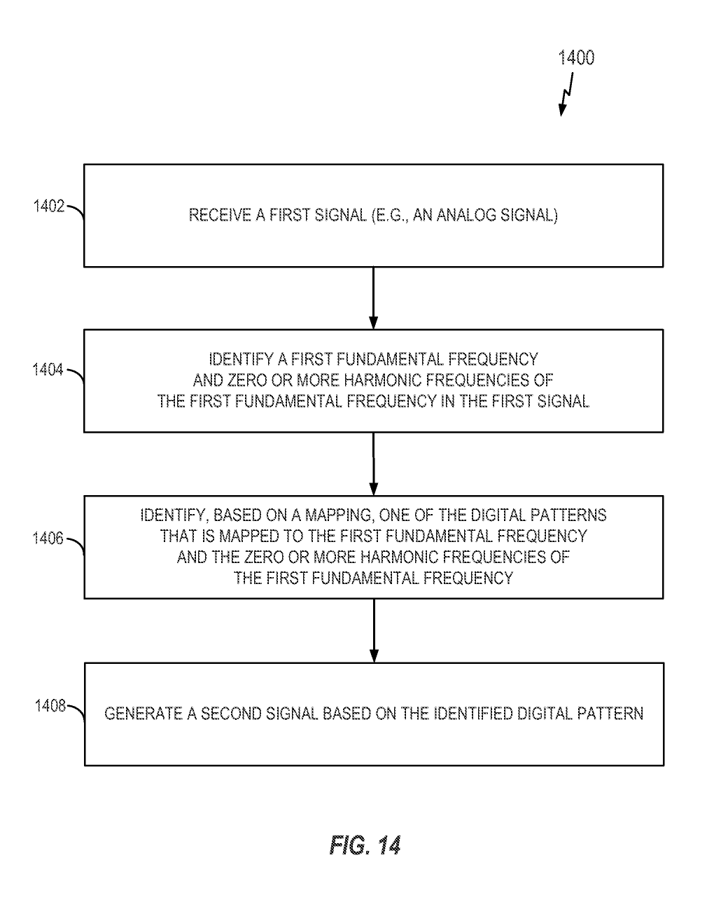

FIG. 14 illustrates a process 1400 for communication in accordance with some aspects of the disclosure. In some implementations, the process 1400 may be a form of the process 1200 of FIG. 12. The process 1400 may take place within a processing circuit (e.g., the processing circuit 1110 of FIG. 11), which may be located in an electronic device or some other suitable apparatus. In some implementations, the process 1400 represents operations performed by the apparatus 800 of FIG. 8, or the apparatus 1000 of FIG. 10. Of course, in various aspects within the scope of the disclosure, the process 1400 may be implemented by any suitable apparatus capable of supporting communication operations as taught herein.

At block 1402, an apparatus receives a first signal. For example, a processing circuit may receive a digital representation of an analog signal or a receiver of the apparatus may receive an analog signal.

At block 1404, the apparatus identifies a first fundamental frequency of the first signal and zero or more harmonic frequencies of the first fundamental frequency in the first signal. For example, the apparatus may include a spectrum analyzer that processes the first signal to identify the frequency components of the first signal.

At block 1406, the apparatus identifies, based on a mapping, one of the digital patterns that is mapped to the first fundamental frequency and the zero or more harmonic frequencies of the first fundamental frequency identified at block 1404.

At block 1408, the apparatus generates a second signal based on (e.g., including) the digital pattern identified at block 1406.

### Additional Aspects

One or more of the components, steps, features and/or functions illustrated in the figures may be rearranged and/or combined into a single component, step, feature or function or embodied in several components, steps, or functions. Additional elements, components, steps, and/or functions may also be added without departing from novel features disclosed herein. The apparatus, devices, and/or components illustrated in the figures may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of example processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein. Additional elements, components, steps, and/or functions may also be added or not utilized without departing from the disclosure.

While features of the disclosure may have been discussed relative to certain implementations and figures, all implementations of the disclosure can include one or more of the advantageous features discussed herein. In other words, while one or more implementations may have been discussed as having certain advantageous features, one or more of such features may also be used in accordance with any of the various implementations discussed herein. In similar fashion, while example implementations may have been discussed herein as device, system, or method implementations, it should be understood that such example implementations can be implemented in various devices, systems, and methods.

Also, it is noted that at least some implementations have been described as a process that is depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. In some aspects, a process may correspond to a method, a function, a procedure, a subroutine, a subprogram, etc. When a process corresponds to a function, its termination corresponds to a return of the function to the calling function or the main function. One or more of the various methods described herein may be partially or fully implemented by programming (e.g., instructions and/or data) that may be stored in a machine-readable, computer-readable, and/or processor-readable storage medium, and executed by one or more processors, machines and/or devices.

Those of skill in the art would further appreciate that the various illustrative logical blocks, modules, circuits, and algorithm steps described in connection with the implementations disclosed herein may be implemented as hardware, software, firmware, middleware, microcode, or any combination thereof. To clearly illustrate this interchangeability, various illustrative components, blocks, modules, circuits, and steps have been described above generally in terms of their functionality. Whether such functionality is implemented as hardware or software depends upon the particular application and design constraints imposed on the overall system.

Within the disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another—even if they do not directly physically touch each other. For instance, a first die may be coupled to a second die in a package even though the first die is never directly physically in contact with the second die. The terms “circuit” and “circuitry” are used broadly, and intended to include both hardware implementations of electrical devices and conductors that, when connected and configured, enable the performance of the functions described in the disclosure, without limitation as to the type of electronic circuits, as well as software implementations of information and instructions that, when executed by a processor, enable the performance of the functions described in the disclosure.

As used herein, the term “determining” encompasses a wide variety of actions. For example, “determining” may include calculating, computing, processing, deriving, investigating, looking up (e.g., looking up in a table, a database or another data structure), ascertaining, and the like. Also, “determining” may include receiving (e.g., receiving information), accessing (e.g., accessing data in a memory), and the like. Also, “determining” may include resolving, selecting, choosing, establishing, and the like.

Accordingly, the various features associated with the examples described herein and shown in the accompanying drawings can be implemented in different examples and implementations without departing from the scope of the disclosure. Therefore, although certain specific constructions and arrangements have been described and shown in the accompanying drawings, such implementations are merely illustrative and not restrictive of the scope of the disclosure, since various other additions and modifications to, and deletions from, the described implementations will be apparent to one of ordinary skill in the art. Thus, the scope of the disclosure is only determined by the literal language, and legal equivalents, of the claims which follow.

1. An apparatus for communication, comprising:
a memory device;
a processing circuit coupled to the memory device and configured to:
receive a first signal, and
generate a second signal by using a mapping to transform the first signal between analog and digital forms, wherein the mapping maps different digital patterns to different combinations of a fundamental frequency and zero or more harmonic frequencies of the fundamental frequency.

2. The apparatus of claim 1, wherein:
the first signal comprises a digital pattern;
the second signal comprises an analog signal; and
the transformation of the first signal comprises a transformation of the digital pattern to the analog signal.

3. The apparatus of claim 1, wherein:
the first signal comprises a first digital pattern;
the generation of the second signal comprises identification, based on the mapping, of one of the combinations of the fundamental frequency and zero or more harmonic frequencies of the fundamental frequency that is mapped to the first digital pattern; and
the second signal is generated based on the identified combination.

4. The apparatus of claim 3, wherein the generation of the second signal comprises generation of an analog signal that comprises the identified combination of the fundamental frequency and zero or more harmonic frequencies of the fundamental frequency.

5. The apparatus of claim 3, wherein:
the generation of the second signal comprises generation of an indication of the identified combination of the fundamental frequency and zero or more harmonic frequencies of the fundamental frequency; and
the apparatus further comprises a transmitter configured to generate, based on the indication, an analog signal that comprises the identified combination of the fundamental frequency and zero or more harmonic frequencies of the fundamental frequency.

6. The apparatus of claim 1, wherein the second signal has a periodicity corresponding to a periodicity of the fundamental frequency.

7. The apparatus of claim 1, wherein:
the first signal comprises an analog signal; and
the second signal comprises a digital pattern; and
the transformation of the first signal comprises a transformation of the analog signal to the digital pattern.

8. The apparatus of claim 1, wherein the processing circuit is further configured to:
identify a first fundamental frequency of the first signal and zero or more harmonic frequencies of the first fundamental frequency in the first signal.

9. The apparatus of claim 8, wherein the generation of the second signal comprises:
identification, based on the mapping, of one of the digital patterns that is mapped to the first fundamental frequency and the zero or more harmonic frequencies of the first fundamental frequency; and
generation of an indication of the identified digital pattern.

10. The apparatus of claim 1, wherein the first signal has a periodicity corresponding to a periodicity of the fundamental frequency.

11. The apparatus of claim 1, wherein the mapping maps:
a first digital pattern to a combination of the fundamental frequency and no harmonic frequencies of the fundamental frequency; and
a second digital pattern to a combination of the fundamental frequency and a third harmonic frequency of the fundamental frequency.

12. The apparatus of claim 11, wherein the mapping further maps:
a third digital pattern to a combination of the fundamental frequency, a third harmonic frequency of the fundamental frequency, and a fifth harmonic frequency of the fundamental frequency.

13. The apparatus of claim 12, wherein the mapping further maps:
a fourth digital pattern to a combination of the fundamental frequency, a third harmonic frequency of the fundamental frequency, a fifth harmonic frequency of the fundamental frequency, and a seventh harmonic frequency of the fundamental frequency.

14. The apparatus of claim 13, wherein the mapping further maps:
a fifth digital pattern to a combination of the fundamental frequency, a third harmonic frequency of the fundamental frequency, a fifth harmonic frequency of the fundamental frequency, a seventh harmonic frequency of the fundamental frequency, and a ninth harmonic frequency of the fundamental frequency.

15. A method of communication, comprising:
receiving a first signal; and
generating a second signal by using a mapping to transform the first signal between analog and digital forms, wherein the mapping maps different digital patterns to different combinations of a fundamental frequency and zero or more harmonic frequencies of the fundamental frequency.

16. The method of claim 15, wherein:
the first signal comprises a digital pattern;
the second signal comprises an analog signal; and
the transformation of the first signal comprises transforming the digital pattern to the analog signal.

17. The method of claim 15, wherein:
the first signal comprises a first digital pattern; and
the generation of the second signal comprises identifying, based on the mapping, one of the combinations of the fundamental frequency and zero or more harmonic frequencies of the fundamental frequency that is mapped to the first digital pattern; and
the second signal is generated based on the identified combination.

18. The method of claim 17, wherein the generation of the second signal comprises generating an analog signal that comprises the identified combination of the fundamental frequency and zero or more harmonic frequencies of the fundamental frequency.

19. The apparatus of claim 17, wherein the generation of the second signal comprises:
generating an indication of the identified combination of the fundamental frequency and zero or more harmonic frequencies of the fundamental frequency; and
generating, based on the indication, an analog signal that comprises the identified combination of the fundamental frequency and zero or more harmonic frequencies of the fundamental frequency.

20. The method of claim 15, wherein the second signal has a periodicity corresponding to a periodicity of the fundamental frequency.

21. The method of claim 15, wherein:
the first signal comprises an analog signal; and
the second signal comprises a digital pattern; and
the transformation of the first signal comprises transforming the analog signal to the digital pattern.

22. The method of claim 15, further comprising:
identifying a first fundamental frequency of the first signal and zero or more harmonic frequencies of the first fundamental frequency in the first signal.

23. The method of claim 22, wherein the generation of the second signal comprises:
identifying, based on the mapping, one of the digital patterns that is mapped to the first fundamental frequency and the zero or more harmonic frequencies of the first fundamental frequency; and
generating an indication of the identified digital pattern.

24. The method of claim 15, wherein the first signal has a periodicity corresponding to a periodicity of the fundamental frequency.

25. The method of claim 15, wherein the mapping maps:
a first digital pattern to a combination of the fundamental frequency and no harmonic frequencies of the fundamental frequency; and
a second digital pattern to a combination of the fundamental frequency and a third harmonic frequency of the fundamental frequency.

26. The method of claim 25, wherein the mapping further maps:
a third digital pattern to a combination of the fundamental frequency, a third harmonic frequency of the fundamental frequency, and a fifth harmonic frequency of the fundamental frequency.

27. The method of claim 26, wherein the mapping further maps:
a fourth digital pattern to a combination of the fundamental frequency, a third harmonic frequency of the fundamental frequency, a fifth harmonic frequency of the fundamental frequency, and a seventh harmonic frequency of the fundamental frequency.

28. The method of claim 27, wherein the mapping further maps:
a fifth digital pattern to a combination of the fundamental frequency, a third harmonic frequency of the fundamental frequency, a fifth harmonic frequency of the fundamental frequency, a seventh harmonic frequency of the fundamental frequency, and a ninth harmonic frequency of the fundamental frequency.

29. An apparatus for communication, comprising:
means for receiving a first signal; and
means for generating a second signal by using a mapping to transform the first signal between analog and digital forms, wherein the mapping maps different digital patterns to different combinations of a fundamental frequency and zero or more harmonic frequencies of the fundamental frequency.

30. A non-transitory computer readable medium storing computer executable code, including code to:
receive a first signal; and
generate a second signal by using a mapping to transform the first signal between analog and digital forms, wherein the mapping maps different digital patterns to different combinations of a fundamental frequency and zero or more harmonic frequencies of the fundamental frequency.
